(19) United States
(12) Patent Application Publication
(10) Pub. No.: US 2024/0367670 A1
(43) Pub. Date: Nov. 7, 2024

(54) DISPLAYING OUTPUT DATA FROM A DRIVER ATTENTION MODEL ON A DISPLAY

(71) Applicant: Micron Technology, Inc., Boise, ID (US)

(72) Inventors: Pavana Prakash, Houston, TX (US); Shashank Bangalore Lakshman, Folsom, CA (US); Febin Sunny, Folsom, CA (US); Saideep Tiku, Fort Collins, CO (US); Poorna Kale, Folsom, CA (US)

(21) Appl. No.: 18/640,865

(22) Filed: Apr. 19, 2024

Related U.S. Application Data
(60) Provisional application No. 63/463,466, filed on May 2, 2023.

(51) Int. Cl. B60W 50/14; B60K 35/28; B60W 40/08; G06V 10/82; G06V 20/59; G06V 40/18

(52) U.S. Cl. CPC B60W 50/14; B60K 35/285; B60W 40/08; G06V 10/82; G06V 20/597; G06V 40/18; B60K 2360/177; B60K 2360/785; B60W 2040/0818; B60W 2050/146; B60W 2420/403; B60W 2540/225; B60W 2540/229

(57) ABSTRACT

The present disclosure includes apparatuses, methods, and systems for displaying output data from a driver attention model on a display. In an example, an apparatus can include a sensor, an augmented reality (AR) windshield, a memory, and a processor coupled to the memory, the sensor, and the AR windshield, wherein the processor is configured to receive an initial driver attention model, train the initial driver attention model to create a trained driver attention model, transmit the trained driver attention model, receive a global driver attention model based in part on the trained driver attention model, receive sensor data based on operation of the apparatus, run the global driver attention model on the sensor data to generate output data, and cause the output data to be displayed on the AR windshield.

### PRIORITY INFORMATION

This application claims the benefits of U.S. Provisional Application No. 63/463,466, filed on May 2, 2023, the contents of which are incorporated herein by reference.

### TECHNICAL FIELD

The present disclosure relates generally to apparatuses, methods, and systems for displaying output data from a driver attention model on a display.

### BACKGROUND

A computing device can be, for example, a vehicle, digital sign, wearable device, personal laptop computer, a smart phone, a tablet, and/or redundant combinations thereof, among other types of computing devices. In some examples, a computing device can provide output to a display, thereby providing an augmented reality (AR) experience for a user. AR can overlay virtual objects on a real-world (e.g., natural) environment. For example, AR can add a 3D hologram to reality. In some examples, AR can be an interactive experience of a real-world environment where real-world objects are enhanced by computer-generated perceptual information.

### BRIEF DESCRIPTION OF THE DRAWINGS

FIG. 1 illustrates an example computing system for training a driver attention model in accordance with some embodiments of the present disclosure.

FIG. 2 illustrates a block diagram of a system for training a driver attention model in accordance with some embodiments of the present disclosure.

FIG. 3 illustrates a schematic diagram of a system for displaying output data from a driver attention model on a number of displays in accordance with some embodiments of the present disclosure.

FIG. 4 is a flow diagram corresponding to a method for displaying output data from a driver attention model on a display in accordance with some embodiments of the present disclosure.

FIG. 5 is a block diagram of an example computer system in which embodiments of the present disclosure may operate.

### DETAILED DESCRIPTION

The present disclosure includes apparatuses, methods, and systems for displaying output data from a driver attention model on a display. In an example, an apparatus can include a sensor, an augmented reality (AR) windshield, a memory, and a processor coupled to the memory, the sensor, and the AR windshield, wherein the processor is configured to receive an initial driver attention model, train the initial driver attention model to create a trained driver attention model, transmit the trained driver attention model, receive a global driver attention model based in part on the trained driver attention model, receive sensor data based on operation of the apparatus, run the global driver attention model on the sensor data to generate output data, and cause the output data to be displayed on the AR windshield.

Distracted driving is one of the main causes for road accidents. Displays on a vehicle and/or other computing devices can provide information that may overwhelm and/or distract a driver. Digital signs showing advertisements can also contribute to distracted driving.

Aspects of the present disclosure address the above and other deficiencies by using a driver attention model, which can be an initial driver attention model, a trained driver attention model, and/or a global driver attention model, to determine what is shown on a display to reduce distractions and provide helpful information to a driver. For example, an AR enabled display can be used to mask a portion of the real-world environment and/or add to the real-world environment such that it is perceived as an immersive aspect of the real-world environment. Accordingly, AR can alter a driver's perception of a real-world environment. An AR windshield is used as an example herein, however other displays, such as, a head-up display, a headset, a smart glass, smart contacts, an electronic display, a light field display, a laser, and/or several sources of light can be used to create AR. In some examples, the AR can be shown on a display of a vehicle and/or a digital sign. The AR windshield is a windshield of a vehicle that can display, or on which can be displayed, AR content to augment the driver's perception of what is seen through the windshield.

The sensor data and/or driver attention data can be used to determine the output data displayed on the AR windshield. The sensor data can include a location, direction of travel, and/or speed of a vehicle. The driver attention data can be based on eye-tracking of a driver, for example. The vehicle can include sensors to record the location, direction of travel, and/or speed of the vehicle and a camera to generate the driver attention data including the eye-tracking data of the driver. The driver attention data can be used to determine what the driver is focusing on while driving. The driver attention data can be correlated with the sensor data to determine what the driver is focusing on while driving in a given area.

The driver attention data and/or the sensor data can be input to the driver attention model. The driver attention model can be an artificial neural network (ANN). The driver attention model is configured to and trained to determine what the driver is focusing on while driving. What is shown on the AR windshield can be based on the output of the driver attention model.

A global driver attention model can be built through federated learning. Federated learning describes the training of an algorithm using multiple decentralized computing devices, for example, vehicles. In various examples, each of the vehicles can receive an initial driver attention model. Each initial driver attention model can be trained as a local model that is specific to a vehicle and/or a driver. While the global driver attention model can be an aggregation of what is learned on each vehicle and/or from each driver, creating a more generic global driver attention model at the server than the different initial driver attention models on each vehicle post training. As used herein, the phrase “initial driver attention model” does not mean that the local model is incomplete. In some embodiments, the local model may be substantially similar to the global model, albeit with different weights and biases, for example.

As used herein, “a”, “an”, or “a number of” can refer to one or more of something, and “a plurality of” can refer to two or more such things. For example, a number of computing devices can refer to one or more computing devices, and a plurality of computing devices can refer to two or more computing devices. Additionally, designators such as “N”, as used herein, particularly with respect to reference numerals in the drawings, indicates that a number of the particular feature so designated can be included with a number of embodiments of the present disclosure.

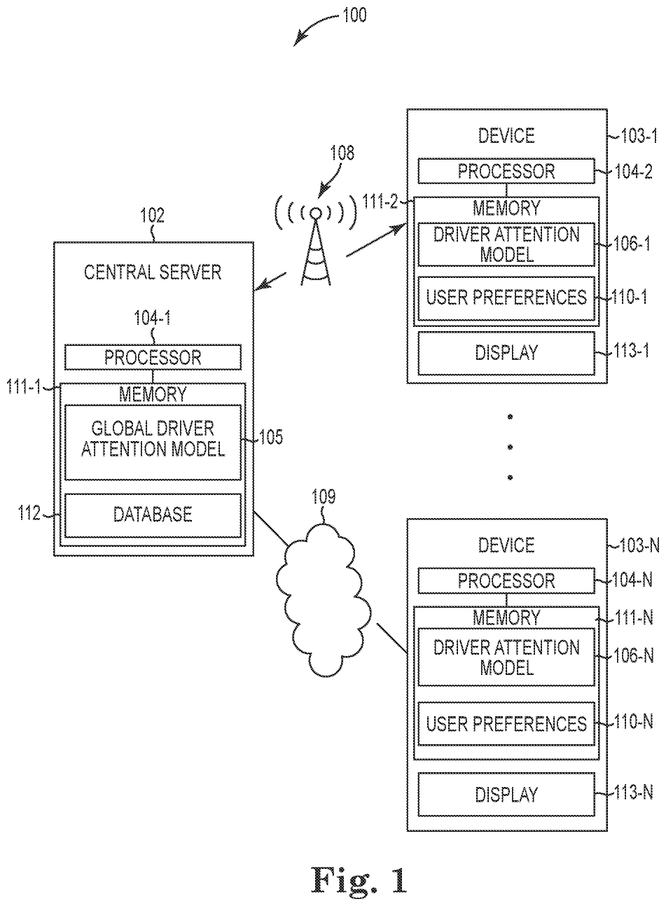

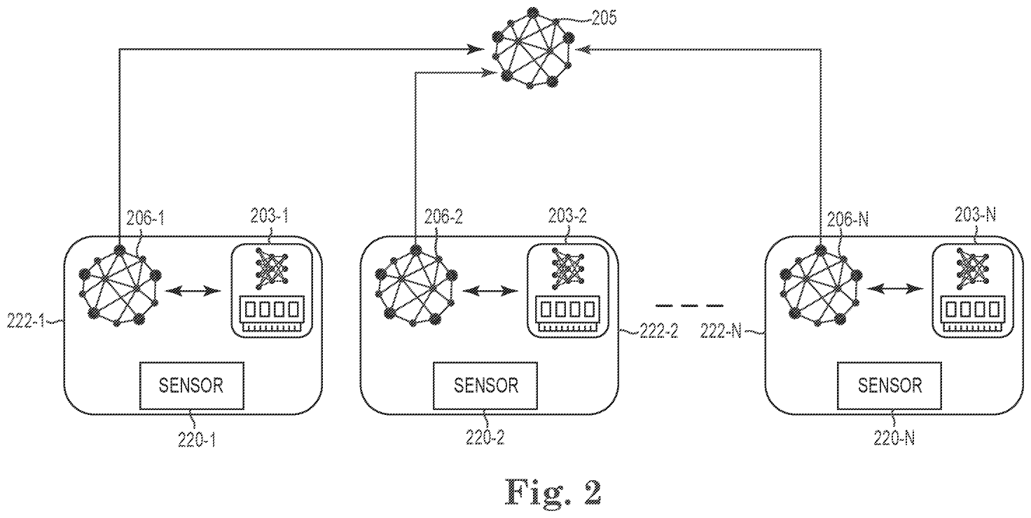

The figures herein follow a numbering convention in which the first digit or digits correspond to the drawing figure number and the remaining digits identify an element or component in the drawing. Similar elements or components between different figures may be identified by the use of similar digits. For example, 105 may reference element “05” in FIG. 1, and a similar element may be referenced as 205 in FIG. 2.

FIG. 1 illustrates an example computing system 100 for training a driver attention model in accordance with some embodiments of the present disclosure. In some examples, the driver attention models can be ANN models. The computing system 100 can comprise a central server 102 and computing devices 103-1, . . . , 103-N (e.g., devices 103-1, 103-N), referred to herein as computing devices 103.

The computing devices 103 can be, but are not limited to, a vehicle, a digital sign, a wearable device, a laptop, a tablet, and/or a mobile device. Accordingly, the computing devices 103 can each include or be coupled to a display 113-1, . . . , 113-N, referred to herein as displays 113. The displays 113 can be an AR windshield, a head-up display, a headset, a smart glass, a smart contact, an electronic display, a light field display, a laser, and/or several sources of light.

The computing system 100, the central server 102, and/or the computing devices 103 can comprise hardware, firmware, and/or software configured to train the global driver attention model 105. As used herein, the driver attention models can include a plurality of weights, biases, and/or activation functions among other variables that can be used to execute an ANN. The central server 102 and the computing devices 103 can further include memory sub-systems 111-1, 111-2, 111-N (e.g., a non-transitory machine-readable medium “MRM”), referred to herein as memory sub-system 111, on which may be stored the global driver attention model 105, an initial driver attention model 106-1, 106-N, referred to herein as initial driver attention model 106, and/or data (e.g., driver attention data, sensor data, user preferences 110-1, 110-N, and/or output data).

The memory sub-systems 111 may comprise memory. The memory may be electronic, magnetic, optical, or other physical storage that stores executable instructions. The memory may be, for example, non-volatile or volatile memory. In some examples, memory can be a non-transitory MRM comprising Random Access Memory (RAM), an Electrically-Erasable Programmable Read-Only Memory “ROM” (EEPROM), a storage drive, an optical disc, and the like.

The memory sub-systems 111 may be disposed within a controller, the central server 102, and/or the computing devices 103. In this example, the global driver attention model 105 and/or the initial driver attention model 106 can be “installed” on the central server 102. The memory sub-systems 111 can be portable, external or remote storage mediums, for example, that allow the central server 102 and/or the computing devices 103 to download the global driver attention model 105 and/or the initial driver attention model 106 from the portable/external/remote storage mediums. In this situation, the global driver attention model 105 and/or the initial driver attention model 106 may be part of an “installation package.” As described herein, the memory sub-systems 111 can be encoded with executable instructions for training the global driver attention model 105 and/or the initial driver attention model 106.

The central server 102 can provide the global driver attention model 105 and/or the initial driver attention model 106 to the computing devices 103 utilizing a wireless network 108 and/or a physical network 109. The computing devices 103 can receive and/or store the initial driver attention model 106. The computing devices 103, comprising the processors 104-2, 104-N, can execute the initial driver attention model 106 utilizing the processors 104-2, 104-N to generate output data. Executing the initial driver attention model 106 can result in updates to the initial driver attention model 106 and can create a trained driver attention model. Although not shown, the output data can be stored in the memory sub-systems 111-2, 111-N of the computing devices 103. In some embodiments, the output data can be displayed on displays 113-1, 113-N of the computing devices 103. The trained driver attention model and/or updates to the initial driver attention model 106 from each of the computing devices 103 can be provided to the central server 102. In various instances, the central server 102 can provide instructions to the computing devices 103 to cause the computing devices 103 to provide their trained driver attention model to the central server 102.

The central server 102 can aggregate the trained driver attention models and/or updates to the initial driver attention model 106 to generate corrections (e.g., training feedback) for the initial driver attention model 106 to create the global driver attention model 105. The corrections can be used to modify the weights, biases, and/or activation functions of the initial driver attention model 106 to create the global driver attention model 105. The corrections and/or the global driver attention model 105 can be provided to the computing devices 103. The computing devices 103 can affect the corrections to update their trained driver attention model to the global driver attention model 105 or replace their trained driver attention model with the global driver attention model 105.

In various examples, the processors 104 can be internal to the memory sub-systems 111 instead of being external to the memory sub-systems 111 as shown. For instance, the processors 104 can be processor in memory (PIM) processors. The processors 104 can be incorporated into the sensing circuitry of the memory sub-systems 111 and/or can be implemented in the periphery of the memory sub-system 111, for instance. The processors 104 can be implemented under one or more memory arrays of the memory sub-system 111.

The memory sub-systems 111-2 and 111-N can store user preferences 110-1, . . . , 110-N, referred to herein as user preferences 110, along with the driver attention model 106. User preferences 110 may also be referred to as driver preferences. The user preferences 110 can be unique to each computing device 103 or to each user of each computing device 103. For example, the computing device 103-1 can have different user preferences than computing device 103-N or when a user is using computing device 103-1, computing device 103-1 can have the same user preferences as when the user is using computing device 103-N. The user preferences 110 can include what, when, and/or how to display, emphasize, and/or occlude data. For example, certain advertisements may be shown on display 113-1 based on user preferences 110-1 and different advertisements may be shown on display 113-N based on user preferences 110-N.

FIG. 2 illustrates a block diagram of a system for training a driver attention model in accordance with some embodiments of the present disclosure. A first computing device 203-1 and a first sensor 220-1 can be located in a first area 222-1, a second computing device 203-2 and a second sensor 220-2 can be located in a second area 222-2, and a third computing device 203-N and a third sensor 220-N can be located in a third area 222-N. The sensors 220-1, 220-2, . . . , 220-N, referred to herein as sensors 220, can record sensor data including a location, direction of travel, and/or speed of a vehicle. The sensors 220 can be, but are not limited to, cameras, gyroscopes, accelerometers, radar, and/or sonar. Sensors 220 can also record driver attention data. For example, a camera can record a driver to generate the driver attention data, which can include eye-tracking data of the driver. The head and/or body of the driver can also be tracked using the camera and included in the driver attention data. The driver attention data and/or the sensor data can be transmitted to a processor (e.g., processor 104 in FIG. 1) of a computing device of the computing devices 203-1, 203-2, . . . , 203-N, referred to herein as computing devices 203, and/or a central server (e.g., central server 102 in FIG. 1).

Initial driver attention models 206-1, 206-2, . . . , 206-N, referred to herein as initial driver attention model 206, can be transmitted to each of the computing devices 203. Sensor data and/or driver attention data can be recorded via each of the corresponding sensors 220 in each area 222. The initial attention model 206 can be trained using the sensor data and/or driver attention data collected at each area 222. For example, the initial attention model 206-1 can be trained using the sensor data and/or driver attention data from the first sensor 220-1, the initial attention model 206-2 can be trained using the sensor data and/or driver attention data from the second sensor 220-2, and the initial attention model 206-N can be trained using the sensor data and/or driver attention data from the third sensor 220-N.

Each initial driver attention model 206, once trained, can be a local model that is specific to each computing device 203 and/or user. The global driver attention model 205 can be an aggregation of what is learned on each computing device 203 and/or from each user, creating a more generic global driver attention model 205 at the server than the initial driver attention models 206 post training. For example, the central server can receive updates to the initial driver attention models 206 and/or receive the trained driver attention models 206 (after they are trained). The central server can aggregate the updates and/or trained driver attention models 206 to create a global driver attention model 205. In a number of embodiments, the global driver attention model 205 and/or the output data from the global driver attention model 205 can be transmitted to a computing device 203, which could be a vehicle or a digital sign.

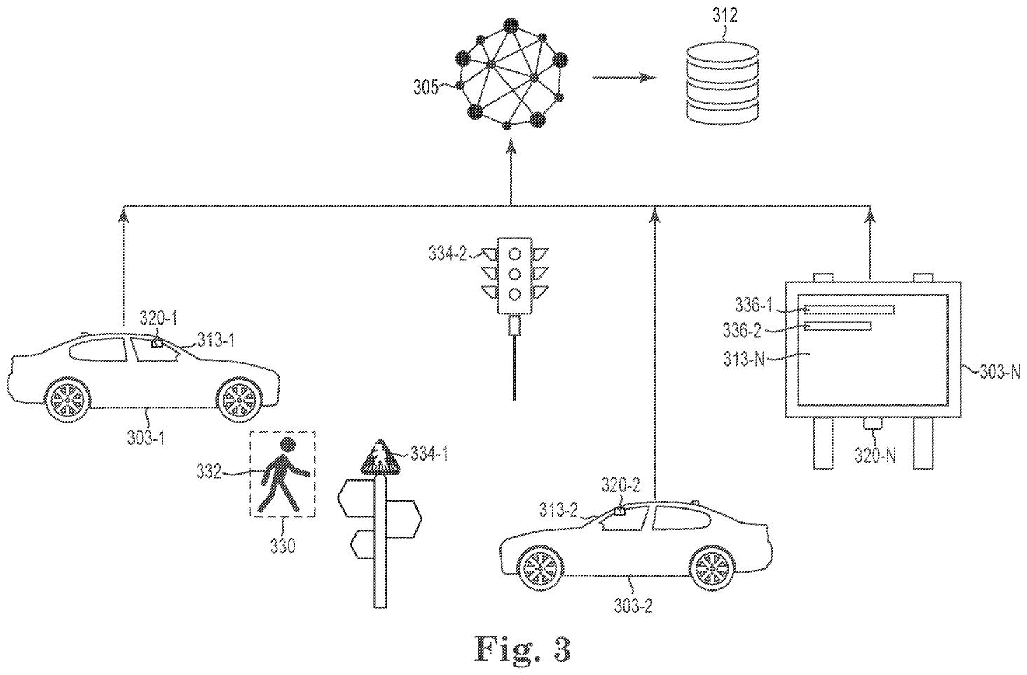

FIG. 3 illustrates a schematic diagram for displaying output data from a driver attention model on a number of displays in accordance with some embodiments of the present disclosure. A first computing device 303-1 can be a vehicle including a display 313-1 and a sensor 320-1, a second computing device 303-2 can be a vehicle including a display 313-2 and a sensor 320-2, and a third computing device 303-N can be a digital sign including a display 313-N and a sensor 320-N, for example. Each of the computing devices 303 can store and/or execute a global driver attention model 305 or an initial driver attention model (e.g., initial driver attention model 206 in FIG. 2).

The global driver attention model 305 can be run on driver attention data and/or sensor data. In a number of embodiments, the global driver attention model 305 can be run on the driver attention data and/or sensor data from each of the computing devices 303 and/or a central server (e.g., central server 102 in FIG. 1). User preferences (e.g., user preferences 110 in FIG. 1), which can include driver preferences, can also be input to the driver attention model 305. For example, a computing device 303 can receive and input driver attention data, sensor data, and/or user preferences into the global driver attention model 305 and/or the computing device 303 can transmit the driver attention data, sensor data, and/or user preferences to the central server where the central server can receive and input the driver attention data, sensor data, and/or user preferences into the global driver attention model 305.

The sensors 320 can provide the driver attention data and the sensor data. For example, footage from a camera inside the vehicle including eye-tracking and/or footage from a camera outside the vehicle can be used by the global driver attention model 305 to determine what the user is paying attention to and/or what the user should be paying attention to.

The driver attention data and/or the sensor data can be input to an initial driver attention model to train the initial driver attention model and/or determine how many people read an advertisement, an amount of time a person spent reading the advertisement, which part of the advertisement the person focused on, and/or a number of times the person viewed the advertisement. The trained driver attention model can be transmitted to the central server, which aggregates trained driver attention models to create the global driver attention model 305. The global driver attention model 305 along with the user preferences can be used by the computing devices 303-1, 303-2, . . . , 303-N to generate output data to display on the displays 313-1, 313-2, . . . , 313-N as digital signage for a driver to comprehend, without having to take their eyes off the road.

Output data from the global driver attention model 305 can be transmitted to display 313 configured to show the output data. The output data of the global driver attention model 305 can be information displayed in a particular way or at a particular time at computing device 303. For example, the display 313-2 can be an AR windshield that may emphasize the pedestrian 332 walking in front of computing device 303-2 by outlining 330 or highlighting the pedestrian 332. Signs 334-1 and 334-2 and/or portions of signs may be emphasized when important for the user of a computing device 303 to notice. The content 336-1 and 336-2 on display 313-N of the computing device 303-N, illustrated as a digital sign, can be revealed or covered by display 313-1, 313-2, and/or 313-N. In some examples, the content 336-1 and 336-2 on display 313-N can be revealed or covered in response to the computing device 303-N displaying the output data. For example, a company can pay to have their content 336-1 and 336-2 including advertisements shown on displays 313-1, 313-2, and/or 313-N. In a number of embodiments, a driver can pay and/or have user preferences set to remove or cover some or all of the content 336-1 and 336-2 including advertisements on displays 313-1, 313-2, and/or 313-N.

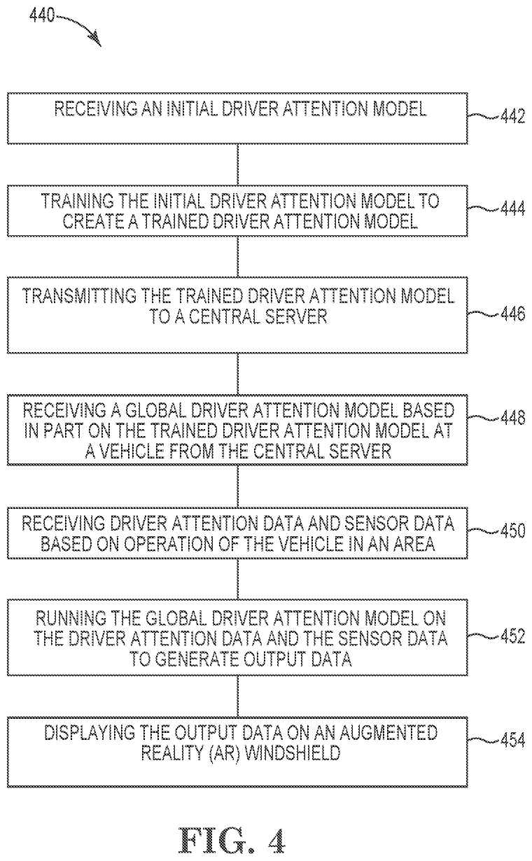

FIG. 4 is a flow diagram corresponding to a method 440 for displaying output data from a driver attention model on a display in accordance with some embodiments of the present disclosure. The method 440 may be performed, in some examples, using a computing system such as those described with respect to FIG. 1.

At 442, the method 440 can include receiving an initial driver attention model. The initial driver attention model can be received at a computing device, for example a vehicle. A central server (e.g., central server 102 in FIG. 1) can transmit the initial driver attention model.

The method 440 can include training the initial driver attention model to create a trained driver attention model at 444. The initial driver attention model can be trained using sensor data, driver attention data, and user preferences at a computing device.

At 446, the method 440 can include transmitting the trained driver attention model to a central server. The central server can aggregate the trained driver attention model with different trained driver attention models from a number of different computing devices.

At 448, the method 440 can include receiving a global driver attention model (e.g., global driver attention model 305 in FIG. 3) based in part on the trained driver attention model at a vehicle from the central server. The global driver attention model can be trained at the central server. In some examples, the global driver attention model can be transmitted from the central server to the vehicle in response to training the global driver attention model. The global driver attention model can be trained at the central server using driver attention data and/or sensor data collected (e.g., recorded) while performing a vehicle operation at a different vehicle. The driver attention data and/or the sensor data at the different vehicle can be recorded using a camera, for example.

The method 440 can include receiving driver attention data and sensor data based on operation of the vehicle in an area at 450. In a number of embodiments, the method 440 can further include the vehicle requesting the driver attention data and sensor data from the sensors prior to receiving the driver attention data and sensor data.

At 452, the method 440 can include running the global driver attention model on the driver attention data and the sensor data to generate output data. In a number of embodiments, the method 440 can further include generating the output data including determining what a driver of the vehicle is focusing on in the area using the global driver attention model. For example, the driver attention model using the driver attention data including eye-tracking data can determine that the driver is focused on an advertisement (e.g., a billboard) and/or a particular portion of the advertisement. The driver attention model can also determine what the driver is not focused on, for instance, a pedestrian crossing the road.

The method 440 can include displaying the output data on an AR windshield at 454. The output data can include computer generated graphics used to occlude, emphasize, and/or display an advertisement, pedestrian movement, traffic light timers, signs, driver behavior, safety information, and/or navigation information. For example, the AR windshield could hide an advertisement and highlight a pedestrian crossing the road. In some examples, an advertisement can be displayed on the AR windshield in response to a company paying to have their advertisement displayed.

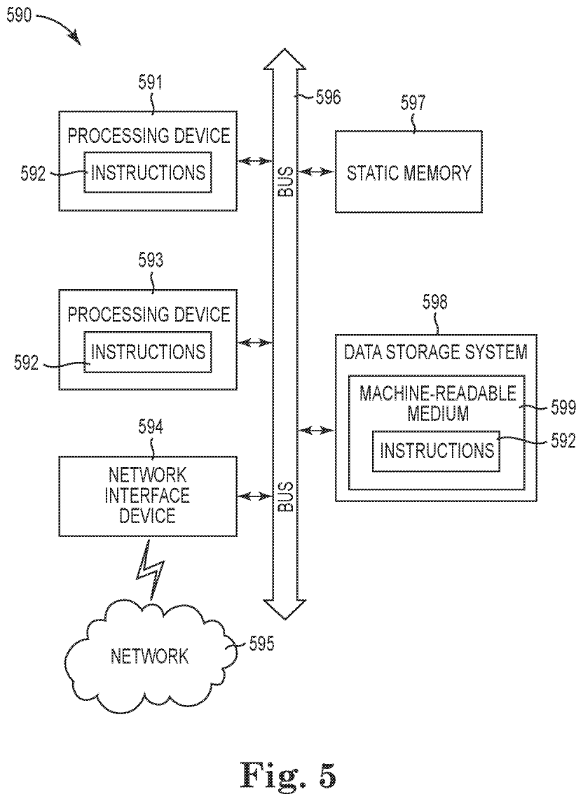

FIG. 5 is a block diagram of an example computer system 590 in which embodiments of the present disclosure may operate. For example, FIG. 5 illustrates an example machine of a computer system 590 within which a set of instructions, for causing the machine to perform any one or more of the methodologies discussed herein, can be executed. In some embodiments, the computer system 590 can correspond to a host system that includes, is coupled to, or utilizes a memory sub-system (e.g., the memory sub-systems 111-1, 111-2, 111-N of FIG. 1). The computer system 590 can be used to perform the operations described herein (e.g., to perform operations corresponding to the processors 104-1, 104-2, 104-N of FIG. 1). In alternative embodiments, the machine can be connected (e.g., networked) to other machines in a LAN, an intranet, an extranet, the Internet, and/or wireless network. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device (e.g., processor) 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

The processing device 591 represents one or more general-purpose processing devices such as a microprocessor, a central processing unit, or the like. More particularly, the processing device 591 can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media. The machine-readable storage medium 599, data storage system 598, and/or main memory 593 can correspond to the memory sub-systems 111-1, 111-2, 111-N of FIG. 1.

In one embodiment, the instructions 592 include instructions to implement functionality corresponding to mirroring data to a virtual environment (e.g., using processors 104-1, 104-2, 104-N of FIG. 1). While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus comprising:
a sensor;
an augmented reality (AR) windshield;
a memory; and
a processor coupled to the memory, the sensor, and the AR windshield, wherein the processor is configured to:
receive an initial driver attention model;
train the initial driver attention model to create a trained driver attention model;
transmit the trained driver attention model;
receive a global driver attention model based in part on the trained driver attention model;
receive sensor data based on operation of the apparatus;
run the global driver attention model on the sensor data to generate output data; and
cause the output data to be displayed on the AR windshield.

2. The apparatus of claim 1, wherein the apparatus is a vehicle; and
wherein the sensor is configured to record and transmit the sensor data to the processor.

3. The apparatus of claim 1, wherein the AR windshield is configured to display the output data including pedestrian movement, driver behavior, traffic light timers, signs, safety information, and/or navigation information.

4. The apparatus of claim 1, wherein the sensor data includes a location, direction of travel, and/or speed of the apparatus.

5. The apparatus of claim 1, further comprising a camera, wherein the camera is configured to record a driver to generate driver attention data and transmit the driver attention data to the processor, wherein the processor is configured to run the trained driver attention model on the driver attention data to generate the output data.

6. The apparatus of claim 5, wherein the driver attention data includes eye-tracking data of the driver.

7. The apparatus of claim 5, wherein the processor is configured to run the trained driver attention model on driver preferences, the driver attention data, and the sensor data to generate the output data.

8. An apparatus comprising:
a memory; and
a processor coupled to the memory, wherein the processor is configured to:
transmit an initial driver attention model to each of a plurality of vehicles;
receive a respective trained driver attention model from each of the plurality of vehicles;
aggregate the respective trained driver attention models to create a global driver attention model; and
transmit the global driver attention model to each of the plurality of vehicles.

9. The apparatus of claim 8, wherein the processor is configured to:
run the global driver attention model to generate output data; and
transmit the output data to a digital sign configured to display the output data.

10. The apparatus of claim 9, wherein a portion of the digital sign is covered in response to the digital sign displaying the output data.

11. The apparatus of claim 10, wherein the output data is an advertisement.

12. The apparatus of claim 8, wherein the processor is configured to transmit the global driver attention model to a digital sign.

13. The apparatus of claim 8, wherein the apparatus is a central server configured to store the global driver attention model, driver attention data, and/or sensor data.

14. A method comprising:
receiving an initial driver attention model;
training the initial driver attention model to create a trained driver attention model;
transmitting the trained driver attention model to a central server;
receiving a global driver attention model based in part on the trained driver attention model at a vehicle from the central server;
receiving driver attention data and sensor data based on operation of the vehicle in an area;
running the global driver attention model on the driver attention data and the sensor data to generate output data; and
displaying the output data on an augmented reality (AR) windshield.

15. The method of claim 14, further comprising creating the global driver attention model at the central server.

16. The method of claim 15, further comprising creating the global attention model at the central server using driver attention data and sensor data recorded at a different vehicle.

17. The method of claim 15, further comprising creating the global driver attention model by aggregating the trained driver attention model with different trained driver attention models.

18. The method of claim 14, further comprising determining what a driver of the vehicle is focusing on in the area using the global driver attention model.

19. The method of claim 14, further comprising displaying the output data on the AR windshield including an advertisement.

20. The method of claim 19, further comprising occluding, emphasizing, and/or displaying the advertisement.
